(19) United States
(12) Patent Application Publication
(10) Pub. No.: US 2026/0061680 A1
(43) Pub. Date: Mar. 5, 2026

(54) INJECTION MOLDING APPARATUS AND MATERIAL EJECTION DEVICE

(71) Applicant: SEIKO EPSON CORPORATION, Tokyo (JP)

(72) Inventors: Taiki AKIYAMA, AZUMINO-SHI (JP); Ryoma WATANABE, SHIOJIRI-SHI (JP)

(21) Appl. No.: 19/310,494

(22) Filed: Aug. 26, 2025

(30) Foreign Application Priority Data
Aug. 28, 2024 (JP) 2024-146396

(51) Int. Cl. B29C 45/23; B29C 45/47; B29C 45/76

(52) U.S. Cl. CPC B29C 45/23; B29C 45/47; B29C 45/76; B29C 2945/7605; B29C 2945/76287; B29C 2945/76381; B29C 2945/76568

(57) ABSTRACT

An injection molding apparatus includes an injection unit configured to inject a plasticized material obtained by plasticizing a material of the molded article into the molding die, a mold clamping unit to which the molding die is attached and which is configured to perform mold clamping on the molding die, and a controller configured to control the injection unit and the mold clamping unit, wherein the injection unit includes a plasticizing unit configured to plasticize the material to generate the plasticized material, a nozzle configured to supply the plasticized material to the molding die, a flow path configured to communicate the plasticizing unit and the nozzle with each other, and a supply adjustment mechanism provided to the flow path and configured to adjust a supply amount of the plasticized material from the nozzle to the molding die, the supply adjustment mechanism includes a cylinder coupled to the flow path, a plunger disposed in the cylinder, and a driver configured to drive the plunger, and the flow path and the cylinder are integrally formed of a first member.

The present application is based on, and claims priority from JP Application Serial Number 2024-146396, filed Aug. 28, 2024, the disclosure of which is hereby incorporated by reference herein in its entirety.

### BACKGROUND

### 1. Technical Field

The present disclosure relates to an injection molding apparatus and a material ejection device.

### 2. Related Art

JP-A-2020-157601 discloses an injection molding apparatus including an injection cylinder and an injection plunger. The molten resin is supplied to the injection cylinder from a flow path communicating with a plasticizing unit. By the injection plunger sliding in the injection cylinder, the molten resin is injected from the injection cylinder into a metal mold through a flow path through which the molten resin flows and a nozzle.

JP-A-2020-157601 is an example of the related art.

When the flow path through which the molten resin flows and the injection cylinder are respectively formed of separate members, there is a possibility that the material is retained at a boundary between the flow path and the injection cylinder, or the material enters a minute gap present at the boundary to cause a leakage of the material to the outside of the flow path. Such a problem is not limited to the injection molding apparatus, but is common to a material ejection device including a flow path and a cylinder.

### SUMMARY

According to a first aspect of the present disclosure, there is provided an injection molding apparatus that performs injection molding of a molded article using a molding die including a fixed mold and a movable mold that is movable relatively to the fixed mold. The injection molding apparatus includes an injection unit configured to inject a plasticized material obtained by plasticizing a material of the molded article into the molding die, a mold clamping unit to which the molding die is attached and which is configured to perform mold clamping on the molding die, and a controller configured to control the injection unit and the mold clamping unit, wherein the injection unit includes a plasticizing unit configured to plasticize the material to generate the plasticized material, a nozzle configured to supply the plasticized material to the molding die, a flow path configured to communicate the plasticizing unit and the nozzle with each other, and a supply adjustment mechanism provided to the flow path and configured to adjust a supply amount of the plasticized material from the nozzle to the molding die, the supply adjustment mechanism includes a cylinder coupled to the flow path, a plunger disposed in the cylinder, and a driver configured to drive the plunger, and the flow path and the cylinder are integrally formed of a first member.

According to a second aspect of the present disclosure, a material ejection device is provided. The material ejection device includes a plasticizing unit configured to plasticize a material to generate a plasticized material, a nozzle configured to supply the plasticized material to an outside, a flow path configured to communicate the plasticizing unit and the nozzle with each other, and a supply adjustment mechanism provided to the flow path and configured to adjust a supply amount of the plasticized material from the nozzle to the outside, wherein the supply adjustment mechanism includes a cylinder coupled to the flow path, a plunger disposed in the cylinder, and a driver configured to drive the plunger, and the flow path and the cylinder are integrally formed of a first member.

### BRIEF DESCRIPTION OF THE DRAWINGS

FIG. 1 is a front view illustrating a schematic configuration of an injection molding apparatus according to a first embodiment.

FIG. 2 is a cross-sectional view showing a schematic configuration of the injection molding apparatus.

FIG. 3 is a perspective view showing a schematic configuration of a screw.

FIG. 4 is a schematic plan view of a barrel.

FIG. 5 is a cross-sectional view of a first member.

FIG. 6 is a perspective view of the first member cut partially.

FIG. 7 is a diagram showing a state in which a plunger is disposed in a cylinder.

FIG. 8 is a diagram showing test results of a material replaceability evaluation test.

FIG. 9 is a diagram illustrating a configuration of an injection unit in a second embodiment.

FIG. 10 is a flowchart of protrusion amount adjustment processing in the second embodiment.

### DESCRIPTION OF EMBODIMENTS

### A. First Embodiment

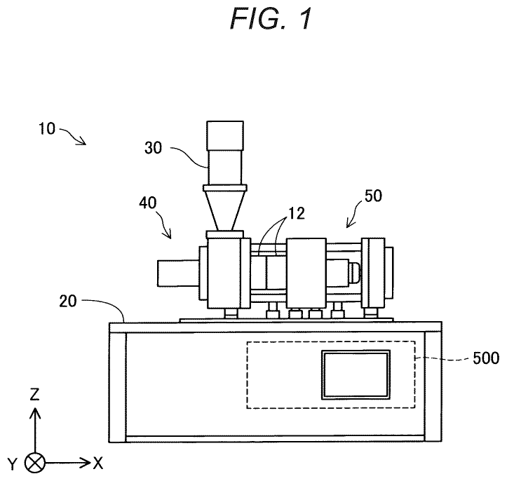

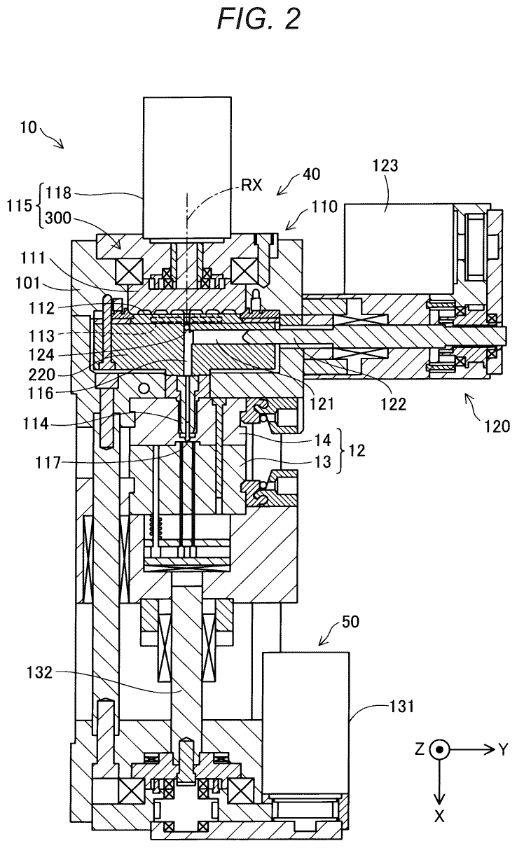

FIG. 1 is a front view illustrating a schematic configuration of an injection molding apparatus 10 according to a first embodiment. FIG. 1 shows arrows indicating X, Y, and Z directions perpendicular to one another. The X direction and the Y direction are directions parallel to a horizontal plane, and the Z direction is a direction opposite to a gravitational direction. X, Y, and Z directions shown in FIG. 2 and subsequent drawings correspond respectively to the X, Y, and Z directions shown in FIG. 1. In the following description, when specifying orientations, positive and negative signs are used together with the directional description defining a positive direction which is a direction pointed by an arrow as “+”, and a negative direction which is an opposite direction to the direction pointed by the arrow as “−”.

The injection molding apparatus 10 includes an injection unit 40 and a mold clamping unit 50. The injection unit 40 is also referred to as a material ejection device. The injection unit 40 and the mold clamping unit 50 are each fixed to the base 20. The base 20 includes a controller 500. The injection molding apparatus 10 injects the plasticized material from the injection unit 40 into the molding die 12 attached to the mold clamping unit 50 to mold a molded article. In the present embodiment, the molding die 12 made of metal is attached to the mold clamping unit 50. The molding die 12 attached to the mold clamping unit 50 is not limited to metallic ones but can also be made of resin or made of ceramic. The molding die 12 made of metal is called a metal mold.

A hopper 30 into which a material for the molded article is put is coupled to the injection unit 40. Examples of the material for a molded article include a thermoplastic resin formed in a pellet shape.

The injection unit 40 plasticizes at least a part of the material supplied from the hopper 30 to generate a plasticized material, and injects the plasticized material into the molding die 12 attached to the mold clamping unit 50. In the present specification, “plasticizing” refers to a concept including melting, and means changing from a solid to a state having fluidity. Specifically, in the case of a material in which glass transition occurs, plasticizing refers to setting the temperature of the material to the glass transition point or higher. In the case of a material in which glass transition does not occur, plasticizing means setting the temperature of the material to the melting point or higher.

The controller 500 is implemented by a computer including a single processor or a plurality of processors, a main storage device, and an input-output interface for inputting and outputting signals from and to the outside. By the processor reading a program on the main storage device and executing the program, the controller 500 controls the injection unit 40 and the mold clamping unit 50 to manufacture the molded article.

FIG. 2 is a cross-sectional view showing a schematic configuration of the injection molding apparatus 10. As described above, the injection molding apparatus 10 includes the injection unit 40 and the mold clamping unit 50. The injection unit 40 includes a plasticizing unit 110, a nozzle 114, a flow path 116, and a supply adjustment mechanism 120. The plasticizing unit 110 plasticizes the material to generate the plasticized material. The nozzle 114 supplies the plasticized material to the outside of the injection unit 40. The flow path 116 communicates the plasticizing unit 110 with the nozzle 114. The supply adjustment mechanism 120 is provided to the flow path 116 and adjusts the supply amount of the plasticized material from the nozzle 114 to the outside.

The plasticizing unit 110 includes a screw 111 and a barrel 112. The screw 111 is housed in a screw case 101 that houses the screw 111. The screw 111 is also referred to as a rotor, a scroll, or a flat screw. The screw 111 is rotationally driven in the screw case 101 about a rotational axis RX by a screw driving unit 115 configured with a drive motor 118 and a reduction mechanism 300. In the present embodiment, the X direction is a direction along the rotational axis RX. A heater 113 for heating the material is embedded in the barrel 112. The rotation of the screw 111 by the screw driving unit 115 and heating by the heater 113 are controlled by the controller 500.

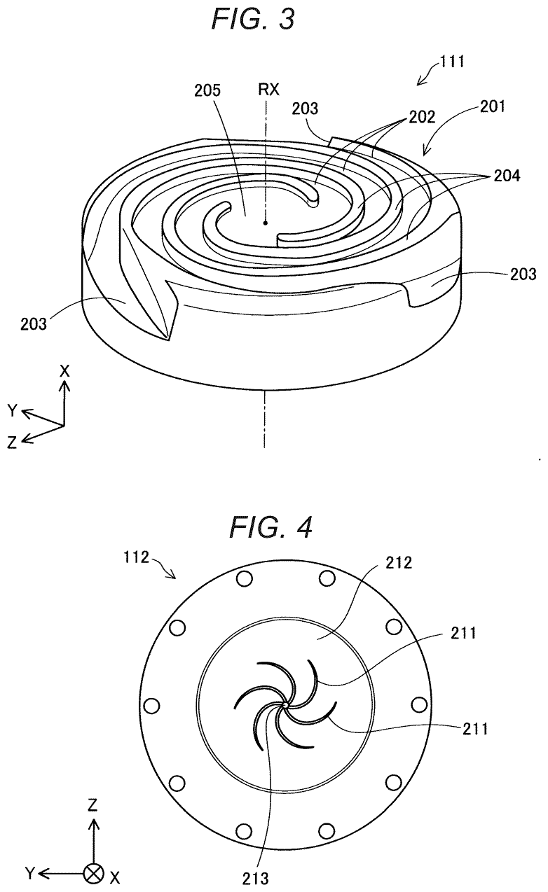

FIG. 3 is a perspective view showing a schematic configuration of the screw 111. The screw 111 has a substantially cylindrical shape in which a length in a direction along a central axis thereof is smaller than a length in a direction perpendicular to the central axis. Spiral grooves 202 are formed around a central portion 205 on a groove forming surface 201 of the screw 111, the groove forming surface 201 facing the barrel 112. The grooves 202 respectively communicate with material inlets 203 formed on a side surface of the screw 111. The material supplied from the hopper 30 is supplied, through the material inlets 203, to the grooves 202. The grooves 202 are formed by being separated by convex ridges 204. FIG. 3 illustrates an example in which three grooves 202 are formed, but the number of grooves 202 may be one or may be two or more. Note that the shape of the groove 202 is not limited to a spiral shape and may be a helical shape or an involute curve shape or may be a shape extending so as to draw an arc from the central portion toward the outer circumference.

FIG. 4 is a schematic plan view of the barrel 112. The barrel 112 has an opposed surface 212 opposed to the groove forming surface 201 of the screw 111. A communication hole 213 through which the plasticized material flows out is formed at the center of the opposed surface 212. A plurality of guide grooves 211 coupled to the communication hole 213 and extending in a spiral shape from the communication hole 213 toward the outer circumference is formed on the opposed surface 212. The material supplied to the grooves 202 of the screw 111 flows along the grooves 202 and the guide grooves 211 due to the rotation of the screw 111, and is guided to the central portion 205 of the screw 111 while being plasticized between the screw 111 and the barrel 112 by the rotation of the screw 111 and the heating by the heater 113. The material flowing into the central portion 205 is guided from the communication hole 213 disposed at the center of the barrel 112 to the flow path 116. The guide grooves 211 are not required to be coupled to the communication hole 213. Further, the guide grooves 211 are not required to be provided to the barrel 112.

As shown in FIG. 2, the supply adjustment mechanism 120 includes a cylinder 121, a plunger 122, and a plunger driver 123 that drives the plunger 122. The supply adjustment mechanism 120 adjusts a supply amount of the plasticized material from the nozzle 114 to the outside of the injection unit 40, that is, the molding die 12 under the control of the controller 500.

The cylinder 121 is coupled to the flow path 116. The plunger 122 is disposed inside the cylinder 121. The plunger 122 slides on the inside of the cylinder 121 and pressure-feeds the plasticized material located in the cylinder 121 to the nozzle 114. The plunger 122 is driven by the plunger driver 123 configured with a motor.

The molding die 12 includes a movable mold 13 and a fixed mold 14. The movable mold 13 and the fixed mold 14 are disposed to face each other, and have a cavity 117, which is a space according to a shape of the molded article, therebetween. The plasticized material pressure-fed by the supply adjustment mechanism 120 is injected into the cavity 117 from the nozzle 114.

The mold clamping unit 50 includes a molding die driver 131 and has a function of opening and closing the movable mold 13 and the fixed mold 14. Under the control of the controller 500, the mold clamping unit 50 drives the molding die driver 131 implemented by a motor to thereby rotate a ball screw 132 and move the movable mold 13 coupled to the ball screw 132 relatively to the fixed mold 14 to open or close the molding die 12. That is, the fixed mold 14 is stationary in the injection molding apparatus 10, and the molding die 12 is opened or closed by the movable mold 13 moving relatively to the fixed mold 14 at rest.

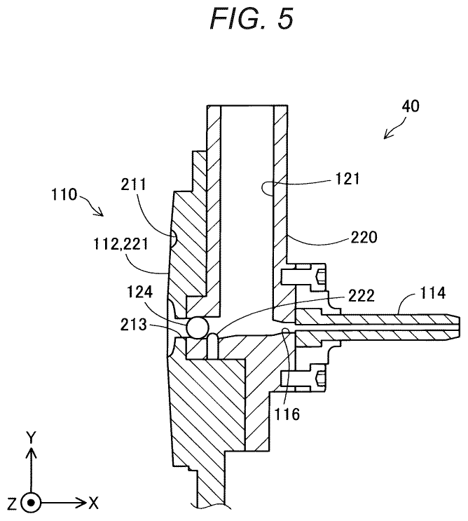

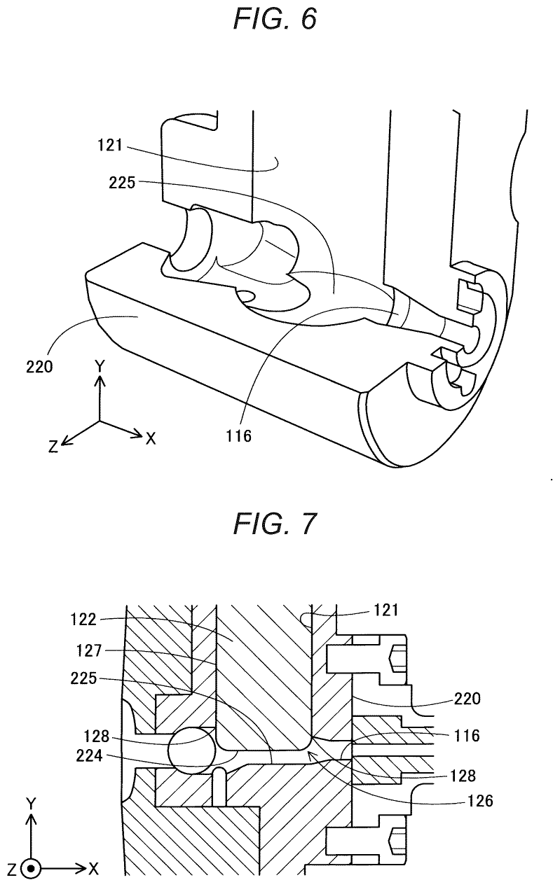

FIG. 5 is a cross-sectional view of a first member 220. FIG. 6 is a perspective view of the first member 220 cut partially. The flow path 116 and the cylinder 121 described above are formed into the first member 220. That is, the flow path 116 and the cylinder 121 are formed of the first member 220 in which the flow path 116 and the cylinder 121 are integrated with each other. The first member 220 can be formed, for example, by cutting a portion corresponding to the flow path 116 and the cylinder 121 from a metal block serving as a material of the first member 220. Besides the above, for example, the first member 220 can be formed by metal bonding a metal material in which the cylinder 121 is formed and a metal material in which the flow path 116 is formed to each other by diffusion bonding or the like. The barrel 112 is in contact with the first member 220. The communication hole 213 of the barrel 112 communicates with the flow path 116 formed in the first member 220. The barrel 112 includes a second member 221 different from the first member 220. The first member 220 and the second member 221 are not integrated with each other. The first member 220 and the second member 221 may be formed of the same type of materials or may be formed of different types of materials.

A valve body 124 is disposed inside the flow path 116 of the first member 220. The valve body 124 is disposed upstream of a coupling portion between the flow path 116 and the cylinder 121 in the flow path 116. In the present embodiment, the valve body 124 has a spherical shape. The position of the valve body 124 when the plasticized material flows from the plasticizing unit 110 into the flow path 116 changes when the plasticized material is injected from the nozzle 114. When the plasticized material flows from the plasticizing unit 110 into the flow path 116, the valve body 124 receives the pressure from the plasticizing unit 110 and moves downstream in the flow path 116. When the plasticized material is injected, the valve body 124 receives the pressure from the plunger 122 and moves upstream in the flow path 116. When the plasticized material is injected, the valve body 124 moves upstream in the flow path 116 to close an opening of the flow path 116 to thereby prevent backflow of the plasticized material from the flow path 116 to the plasticizing unit 110. The valve body 124 is also referred to as a check valve.

A wall surface of the flow path 116 is provided with a limiter 222 that limits a variation amount of the position of the valve body 124 when the plasticized material flows from the plasticizing unit 110 into the flow path 116. In the present embodiment, the limiter 222 has a hemispherical shape protruding from the wall surface of the flow path 116. Abase end side portion of the limiter 222 is formed in a columnar shape and is embedded in a wall surface of the flow path 116. A maximum cross-sectional area of a portion of the limiter 222 protruding into the flow path 116 is smaller than a maximum cross-sectional area of the valve body 124. That is, in the present embodiment, the diameter of the hemispherical portion of the limiter 222 is smaller than the diameter of the valve body 124 having the spherical shape.

FIG. 7 is a diagram illustrating a state in which the plunger 122 is disposed in the cylinder 121. In the present embodiment, a tip 126 of the plunger 122 has a first plane 224. As shown in FIGS. 6 and 7, a wall surface which is a part of a wall surface of the flow path 116 formed in the first member 220, and which faces the tip 126 of the plunger 122 has a second plane 225 along the first plane 224. In the present embodiment, the first plane 224 and the second plane 225 are parallel to each other. In the present embodiment, when the injection of the plasticized material into the molding die 12 is completed, a distance between the first plane 224 and the second plane 225 is about 0.5 mm. On this occasion, the tip 126 of the plunger 122 is located in the flow path 116, and a side surface 127 of the plunger 122 comes into contact with an opening edge portion 128 of the cylinder 121.

In the injection unit 40, by the controller 500 controlling the plunger driver 123, a suction operation and a feeding operation are executed. The suction operation is an operation of sucking the plasticized material from the flow path 116 into the cylinder 121 by moving the plunger 122 backward. The feeding operation is an operation of moving the plunger 122 forward to thereby feed, to the nozzle 114, the plasticized material sucked into the cylinder 121. “Forward” refers to a direction in which the plunger 122 approaches the flow path 116. “Backward” refers to a direction in which the plunger 122 moves away from flow path 116. The controller 500 controls an injection amount, an injection speed, and injection pressure of the plasticized material from the nozzle 114 by adjusting a movement amount and a movement speed of the plunger 122 in the suction operation and the feeding operation. Note that the suction operation is also referred to as a measuring operation.

After the feeding operation is performed by the injection unit 40 and the plasticized material is injected from the nozzle 114 into the cavity 117, the mold clamping unit 50 drives the ball screw 132 to move the movable mold 13 in the +X direction, which is the mold opening direction, relatively to the fixed mold 14 to thereby perform the mold opening. When the mold opening is performed, an ejector pin (not shown) incorporated in the movable mold 13 relatively protrudes into the cavity 117, and the molded article is released from the cavity 117.

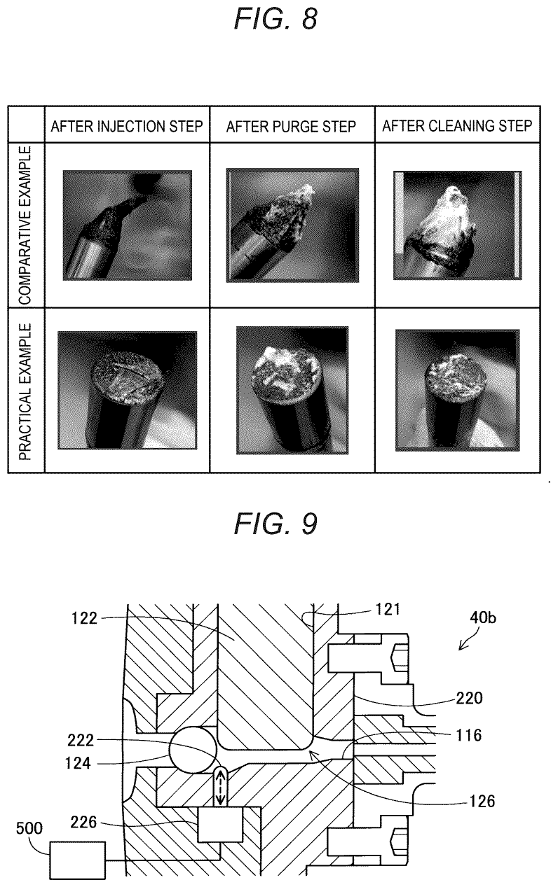

FIG. 8 is a diagram showing test results of a material replaceability evaluation test. In this material replaceability evaluation test, the plunger in the first embodiment having a flat tip and a plunger having a conical tip were used to observe an adhesion state of the resin to the plunger in the material replacement work of the injection molding apparatus. FIG. 8 shows the plunger having the flat tip as a practical example and the plunger having the conical tip as a comparative example.

In the material replaceability evaluation test, an injection step, a purge step, and a cleaning step were performed. In the injection step, injection molding for five shots was performed using an acrylonitrile butadiene styrene (ABS) resin as a material. In the purge step, after the injection step, a commercially available cleaning agent for molding machines was injected for five shots to purge the material in the flow path 116. In the cleaning step, the tip of the plunger was located in the flow path, the distance between the tip of the plunger and the flow path was set to 3.5 mm, and the cleaning agent for molding machines was made to continuously flow for 100 seconds. FIG. 8 shows respective images of the tip portions of the plungers of the practical example and the comparative example after the injection step, after the purge step, and after the cleaning step, respectively.

As shown in FIG. 8, after the injection step, a large amount of molten resin adhered to the tip portion of the plunger of the comparative example, whereas the amount of resin adhered to the plunger of the practical example was not so much. After the purge step, substantially the same amount of cleaning agent was attached in both the comparative example and the practical example. After the cleaning step, a large amount of cleaning agent was attached to the tip portion of the plunger of the comparative example, but the amount of the cleaning agent attached to the tip portion of the plunger of the practical example was small. Therefore, according to the material replaceability evaluation test, it was confirmed that the material replacement and the color replacement can be performed more easily in the plunger having the flat chip than in the plunger having the conical tip.

According to the injection molding apparatus 10 in the first embodiment described hereinabove, the flow path 116 through which the plasticized material flows and the cylinder 121 on which the plunger 122 slides are integrally formed of the first member 220. Therefore, there is no gap between the flow path 116 and the cylinder 121. Accordingly, it is possible to prevent the plasticized material from leaking from the gap between the flow path 116 and the cylinder 121 or the plasticized material from being retained in the gap between the flow path 116 and the cylinder 121. As a result, it is possible to reduce a possibility that the injection molding apparatus 10 is contaminated due to the leakage of the material or a possibility that a member in contact with the flow path 116 is damaged due to an increase in surface pressure caused by the leakage of the material.

Further, in the present embodiment, the valve body 124 that suppresses the backflow of the plasticized material from the flow path 116 to the plasticizing unit 110 is provided not in the communication hole 213 of the barrel 112 or the boundary between the barrel 112 and the first member 220 but in the flow path 116 formed in the first member 220. Therefore, it is possible to suppress an occurrence of the leakage of the material from an area between the barrel 112 and the first member 220 when the plasticized material is injected. As a result, it is possible to reduce the possibility that the injection molding apparatus 10 is contaminated due to the leakage of the material or damage occurs in the boundary portion between the first member 220 and the barrel 112 due to an increase in surface pressure caused by the leakage of the material.

Further, in the present embodiment, the limiter 222 that limits the amount of change in the position of the valve body 124 is disposed on the wall surface of the flow path 116. Therefore, the movement of the valve body can be limited with a simple structure. In particular, in the present embodiment, the cross-sectional area of the limiter 222 is smaller than the cross-sectional area of the valve body 124. That is, in the present embodiment, the limiter 222 is formed to be small in size. Accordingly, since the pressure applied to the limiter 222 at the time of injection can be reduced, the possibility that damage occurs in the limiter 222 can be reduced, and the leakage of the material from the damaged portion can be suppressed.

Further, in the present embodiment, when the injection of the plasticized material is completed, the tip 126 of the plunger 122 is located in the flow path 116, and the side surface 127 of the plunger 122 comes into contact with the opening edge portion 128 of the cylinder 121. Therefore, when the plasticized material is injected, a possibility that the material in the flow path 116 enters the cylinder 121 to cause the retention of the material is suppressed. Accordingly, it is possible to suppress the occurrence of wear or damage of the plunger 122 or the cylinder 121 due to solidification of the retained material. In addition, when the material used for molding is switched, it is possible to prevent the retained material from being mixed with the material after switching.

Further, in the present embodiment, the tip 126 of the plunger 122 has the first plane 224, and the wall surface of the flow path 116 facing the tip 126 of the plunger 122 has the second plane 225 along the first plane 224. Therefore, when the plasticized material is injected, a gap generated between the tip 126 of the plunger 122 and the flow path 116 can be made small. As a result, since the amount of the material retained in the flow path 116 after the injection can be reduced, the material change and the color change can easily be performed.

### B. Second Embodiment

FIG. 9 is a diagram illustrating a configuration of an injection unit 40b in a second embodiment. The injection unit 40b in the second embodiment includes a limiter driver 226 that drives the limiter 222. The limiter driver 226 is controlled by the controller 500 and is configured to be able to change the amount of protrusion of the limiter 222 from the wall surface of the flow path 116. Other configurations in the second embodiment are the same as those in the first embodiment.

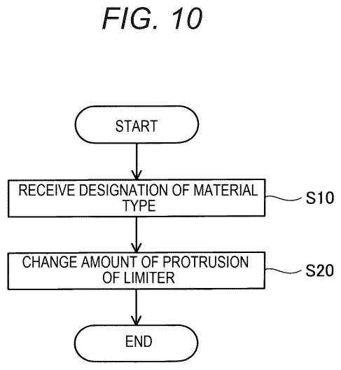

FIG. 10 is a flowchart of protrusion amount adjustment processing executed in the second embodiment. The protrusion amount adjustment processing is processing for adjusting a length of the protrusion of the limiter 222 into the flow path 116. The protrusion amount adjustment processing is executed before a molding cycle of the injection molding is started.

In step S10, the controller 500 receives designation of the type of the material. The type of the material is received by, for example, the user operating an operation unit coupled to the controller 500.

In step S20, the controller 500 changes the amount of the protrusion of the limiter 222 from the wall surface of the flow path 116 in accordance with the designated type of the material. In the present embodiment, the controller 500 sets the protrusion amount of the limiter 222 so that the higher the viscosity of the material, the smaller the protrusion amount. In other words, the lower the viscosity of the material, the larger the protrusion amount of the limiter 222 is made. Since the tip of the limiter 222 is formed in a hemispherical shape, the movement amount of the valve body 124 in the downstream direction becomes large when the protrusion amount of the limiter 222 is small, and the movement amount of the valve body 124 in the downstream direction becomes small when the protrusion amount of the limiter 222 is large. As the amount of the movement of the valve body 124 in the downstream direction increases, the gap between the valve body 124 and the flow path 116 increases. Therefore, by reducing the protrusion amount of the limiter 222 as the viscosity of the material increases, the material becomes easy to flow through the flow path 116.

According to the second embodiment described hereinabove, by changing the amount of the protrusion of the limiter 222 from the wall surface of the flow path 116 in accordance with the viscosity of the material, the controller 500 can shorten the time during which the material high in viscosity flows into the cylinder 121. As a result, it is possible to increase the manufacturing efficiency of the molded article using the material high in viscosity.

### C. Other Embodiments

(C1) In the embodiment described above, the valve body 124 is disposed in the flow path 116 formed in the first member 220. In contrast, the valve body 124 may be disposed in the communication hole 213 of the barrel 112 instead of the inside of the flow path 116.

(C2) In the embodiment described above, the cross-sectional area of the limiter 222 is smaller than the cross-sectional area of the valve body 124. In contrast, it is possible to adopt a configuration in which the cross-sectional area of the limiter 222 is larger than the cross-sectional area of the valve body 124.

(C3) In the embodiment described above, when the injection of the plasticized material is completed, the tip 126 of the plunger 122 is located in the flow path 116, and the side surface 127 of the plunger 122 is in contact with the opening edge portion 128 of the cylinder 121. In contrast, when the injection of the plasticized material is completed, the tip 126 of the plunger 122 may remain in the cylinder 121.

(C4) In the embodiment described above, the tip 126 of the plunger 122 is a plane, and the wall surface of the flow path 116 facing the tip 126 of the plunger 122 is also a plane. In contrast, the tip 126 of the plunger 122 is not required to be a plane, and the wall surface of the flow path 116 facing the tip 126 is not required to be a plane.

(C5) The injection unit 40 in the first embodiment described above may be installed as a material ejection device in a three-dimensional shaping apparatus. The three-dimensional shaping apparatus includes a stage facing the nozzle 114 of the material ejection device. The three-dimensional shaping apparatus shapes a three-dimensional shaped article by stacking the plasticized material ejected from the nozzle 114 on the stage while changing the relative position between the nozzle 114 and the stage. The plunger 122 provided to the material ejection device is used to, for example, temporarily decrease or increase the flow rate of the plasticized material to be ejected toward the stage. Note that the material ejection device provided to the three-dimensional shaping apparatus is not required to include the valve body 124.

### D. Other Aspects

The present disclosure is not limited to the embodiments described above, and can be implemented in various aspects without departing from the scope or the spirit of the present disclosure. For example, technical features in the embodiments corresponding to technical features in aspects described below can be replaced or combined as appropriate in order to solve a part or all of the problems described above or in order to achieve a part or all of the advantages described above. In addition, the technical features can be deleted as appropriate unless described as essential features in the present specification.

(1) According to a first aspect of the present disclosure, there is provided an injection molding apparatus that performs injection molding of a molded article using a molding die including a fixed mold and a movable mold that is movable relatively to the fixed mold. The injection molding apparatus includes an injection unit configured to inject a plasticized material obtained by plasticizing a material of the molded article into the molding die, a mold clamping unit to which the molding die is attached and which is configured to perform mold clamping on the molding die, and a controller configured to control the injection unit and the mold clamping unit, wherein the injection unit includes a plasticizing unit configured to plasticize the material to generate the plasticized material, a nozzle configured to supply the plasticized material to the molding die, a flow path configured to communicate the plasticizing unit and the nozzle with each other, and a supply adjustment mechanism provided to the flow path and configured to adjust a supply amount of the plasticized material from the nozzle to the molding die, the supply adjustment mechanism includes a cylinder coupled to the flow path, a plunger disposed in the cylinder, and a driver configured to drive the plunger, and the flow path and the cylinder are integrally formed of a first member.

According to such an aspect, the flow path through which the plasticized material flows and the cylinder are integrally formed of the first member. Therefore, there is no gap between the flow path and the cylinder. Accordingly, it is possible to prevent the plasticized material from leaking from the gap between the flow path and the cylinder or the plasticized material from being retained in the gap between the flow path and the cylinder.

(2) In the aspect described above, the plasticizing unit may include a screw, and a barrel formed of a second member different from the first member and having a communication hole communicating with the flow path, the injection unit may include a valve body configured to suppress backflow of the plasticized material from the flow path to the plasticizing unit during injection of the plasticized material, and the valve body may be disposed in the flow path. According to such an aspect, the valve body is not provided to the communication hole of the barrel, but is provided to the flow path formed in the first member. Therefore, it is possible to prevent the material from leaking from the bonding portion between the plasticizing unit and the first member when the plasticized material is injected. As a result, it is possible to reduce the possibility that the injection molding apparatus 10 is contaminated due to the leakage of the material or the bonding portion between the first member and the barrel is damaged due to the increase in the surface pressure caused by the leakage of the material.

(3) In the aspect described above, there may further be provided a valve body a position of which changes between when the plasticized material flows into the flow path from the plasticizing unit and when the plasticized material is injected, wherein a limiter configured to limit a change amount of the position of the valve body when the plasticized material flows into the flow path from the plasticizing unit may be disposed on a wall surface of the flow path. According to such an aspect, the movement of the valve body can be limited with a simple structure.

(4) In the aspect described above, a cross-sectional area of the limiter may be smaller than a cross-sectional area of the valve body. According to such an aspect, since the limiter is formed to be small in size, the pressure applied to the limiter at the time of injection can be reduced. As a result, it is possible to reduce the possibility that damage occurs in the limiter.

(5) In the aspect described above, the controller may change an amount of protrusion of the limiter from the wall surface of the flow path in accordance with viscosity of the material. According to such an aspect, an amount of displacement of the valve body can appropriately be adjusted in accordance with the viscosity or the like of the material.

(6) In the aspect described above, when the injection of the plasticized material is completed, a tip of the plunger may be located in the flow path, and a side surface of the plunger may be in contact with an opening edge portion of the cylinder. According to such an aspect, the possibility that the material in the flow path enters the cylinder at the time of injection and the retention of the material occurs is suppressed. As a result, it is possible to suppress solidification of the retained material, and the occurrence of abrasion or damage of the plunger or the cylinder with the solidified material. In addition, when the material used for molding is switched, it is possible to prevent the retained material from being mixed with the material after switching.

(7) In the aspect described above, the tip has a first plane, and a wall surface of the flow path facing the tip has a second plane along the first plane. According to such an aspect, it is possible to reduce a gap generated between the tip of the plunger and the flow path at the time of injection. As a result, since the amount of the material retained in the flow path after the injection can be reduced, the material change and the color change can easily be performed.

(8) According to a second aspect of the present disclosure, a material ejection device is provided. The material ejection device includes a plasticizing unit configured to plasticize a material to generate a plasticized material, a nozzle configured to supply the plasticized material to an outside, a flow path configured to communicate the plasticizing unit and the nozzle with each other, and a supply adjustment mechanism provided to the flow path and configured to adjust a supply amount of the plasticized material from the nozzle to the outside, wherein the supply adjustment mechanism includes a cylinder coupled to the flow path, a plunger disposed in the cylinder, and a driver configured to drive the plunger, and the flow path and the cylinder are integrally formed of a first member.

What is claimed is:

1. An injection molding apparatus configured to perform injection molding of a molded article using a molding die including a fixed mold and a movable mold that is movable relatively to the fixed mold, the apparatus comprising:
an injection unit configured to inject a plasticized material obtained by plasticizing a material of the molded article into the molding die;
a mold clamping unit to which the molding die is attached and which is configured to perform mold clamping on the molding die; and
a controller configured to control the injection unit and the mold clamping unit, wherein
the injection unit includes
a plasticizing unit configured to plasticize the material to generate the plasticized material,
a nozzle configured to supply the plasticized material to the molding die,
a flow path configured to communicate the plasticizing unit and the nozzle with each other, and
a supply adjustment mechanism provided to the flow path and configured to adjust a supply amount of the plasticized material from the nozzle to the molding die,
the supply adjustment mechanism includes
a cylinder coupled to the flow path,
a plunger disposed in the cylinder, and
a driver configured to drive the plunger, and
the flow path and the cylinder are integrally formed of a first member.

2. The injection molding apparatus according to claim 1, wherein
the plasticizing unit includes
a screw, and
a barrel formed of a second member different from the first member and having a communication hole communicating with the flow path,
the injection unit includes a valve body configured to suppress backflow of the plasticized material from the flow path to the plasticizing unit during injection of the plasticized material, and
the valve body is disposed in the flow path.

3. The injection molding apparatus according to claim 1, further comprising
a valve body a position of which changes between when the plasticized material flows into the flow path from the plasticizing unit and when the plasticized material is injected, wherein
a limiter configured to limit a change amount of the position of the valve body when the plasticized material flows into the flow path from the plasticizing unit is disposed on a wall surface of the flow path.

4. The injection molding apparatus according to claim 3, wherein
a cross-sectional area of the limiter is smaller than a cross-sectional area of the valve body.

5. The injection molding apparatus according to claim 3, wherein
the controller changes an amount of protrusion of the limiter from the wall surface of the flow path in accordance with viscosity of the material.

6. The injection molding apparatus according to claim 1, wherein
when the injection of the plasticized material is completed, a tip of the plunger is located in the flow path, and a side surface of the plunger is in contact with an opening edge portion of the cylinder.

7. The injection molding apparatus according to claim 6, wherein
the tip has a first plane, and
a wall surface of the flow path facing the tip has a second plane along the first plane.

8. A material ejection device comprising:
a plasticizing unit configured to plasticize a material to generate a plasticized material;
a nozzle configured to supply the plasticized material to an outside;
a flow path configured to communicate the plasticizing unit and the nozzle with each other; and
a supply adjustment mechanism provided to the flow path and configured to adjust a supply amount of the plasticized material from the nozzle to the outside, wherein
the supply adjustment mechanism includes
a cylinder coupled to the flow path,
a plunger disposed in the cylinder, and
a driver configured to drive the plunger, and
the flow path and the cylinder are integrally formed of a first member.
